(19) United States
(12) Patent Application Publication
(10) Pub. No.: US 2012/0258779 A1
(43) Pub. Date: Oct. 11, 2012

(54) Holder For Mobile Telecommunications Device

(76) Inventor: Laura L. Ripes, Vernon Hills, IL (US)

(21) Appl. No.: 13/081,139

(22) Filed: Apr. 6, 2011

(51) Int. Cl. H04M 1/04

(52) U.S. Cl. 455/575.9

(57) ABSTRACT

A holder for a mobile telecommunications device designed to reduce distraction to the driver that securely encloses and envelopes the mobile telephone in a sound, vibration, and shock dampening material. The mobile telecommunications device is enclosed within a foam-lined container, thereby muffling sounds and vibrations emitted by the mobile telephone and reducing distractions to a driver. The holder provides a protective storage receptacle for the mobile telephone in the passenger compartment of a vehicle and decreases distractions to a driver of the vehicle from the mobile telecommunications device while maintaining the mobile telecommunications device in a functioning state and in a convenient and readily accessible location in the vehicle.

### BACKGROUND OF THE INVENTION

1. Field of the Invention

The present invention relates to a holder for a mobile telecommunications device.

2. Description of the Background of the Invention

Mobile telephones for wireless telecommunication, such as cell phones, car phones, smart phones, and satellite phones, for example, are often carried by a user in an automobile or other vehicle. However, due to the relatively small size of many mobile telephones it is often convenient or expedient to provide a special holder for the mobile phone inside the passenger compartment of the automobile in order to prevent the telephone from being lost inside the passenger compartment or being placed in an undesired location, such as in a seat where a person could sit on the telephone and break it. Therefore, various types of holders for mobile telephones have been developed that are specially adapted for use inside the passenger compartment of an automobile in order to provide a convenient and relatively stable storage location for the mobile telephone.

Several mobile telephone holders have been designed so as to readily fit in a cup holder inside the passenger compartment. In general, these mobile telephone holders have an outer form factor generally in the shape of a cup filled with various cavities on an interior portion of the holder for holding the mobile telephone and, in some instances, other items, such as pens, pencils, and notepads. Frequently, such designs include some sort of foam body and/or lining that may help cushion the mobile telephone from impacts, such as when the automobile hits a pothole. Some various examples of such designs are shown in Edwards U.S. Patent Application Publication No. 2002/0094079, Heininger U.S. Patent Application Publication No. 2002/0049081, Deadman U.S. Patent Application Publication No. 2007/0012706, Close U.S. Pat. No. 6,396,925, and DE 10 2006 040 273 A1. Each of these mobile telephone holders appears to be designed to allow a driver of the automobile to both hear a ring or notification from the mobile telephone when carried therein and to have quick and easy access to the mobile telephone while driving by having at least a portion of the telephone exposed to the driver.

Unfortunately, although the use of a mobile telephone while driving an automobile may be convenient and/or more efficient, it has also become clear in recent years that using a mobile telephone while driving can greatly increase the risk of crashes and other unsafe driving behavior. For example, young, inexperienced drivers seem to be highly prone to texting on a cell phone as a form of communication all the time, but recent studies have shown that texting while driving greatly increases the risk of crashes or dangerous driving. A problem is that such young, inexperienced drivers often seem unable to avoid looking at their phones as soon as a text arrives or a text notification is provided by the phone. In fact, texting has become such a common practice that people often do it out of habit not realizing just how distracting and deadly these actions can be.

Even though improper use of a mobile telephone while driving is dangerous, it is also well understood that having a mobile telephone available to a person while driving can also greatly increase various safety factors. For example, if a driver does get into a crash or has mechanical trouble, it could be extremely important to have the use of a cell phone or other mobile telecommunications device to call for help. In the case of a crash, it is also important for the passenger or driver to be able to easily find the mobile telephone or telecommunications device in good working order, and therefore a special protective carrier would be desirable.

In view of these facts, the inventor has developed a holder for a mobile telecommunications device, such as a mobile telephone, pager, or other mobile device that is capable of receiving wireless telecommunications such as telephone calls, text messages, emails, and the like. In some uses, the holder decreases distractions to the driver of a vehicle, such as an automobile, motorcycle, boat, or other vehicle, by the mobile telecommunications device while maintaining the mobile telecommunications device in a protected and functioning state and in a convenient, fixed, and readily accessible location in the vehicle.

### SUMMARY OF THE INVENTION

According to some aspects, a holder for a mobile telecommunications device includes a container having an interior and an opening into the interior, a lid permanently attached to the container, and a dampening material lining the interior. The lid shifts between a closed position that covers the opening and an open position that exposes the opening. The dampening material dampens sounds, vibrations, and shocks. A cavity in the dampening material is shaped to receive the mobile telecommunications device. The mobile telecommunications device may be inserted into the cavity through the opening when the lid is in the open position, and the cavity is encapsulated by the dampening material when the lid is in the closed position. In this manner, any indications that the mobile telecommunications device in the cavity received an incoming wireless transmission are not observable outside of the housing.

According to other aspects, a holder for a mobile telecommunications device includes a cup-shaped shell having a bottom, a generally cylindrical sidewall, and an opening into an interior at a top of the sidewall. A lid is permanently attached to the shell. The lid is movable from a closed position that covers the opening to an open position that exposes the opening. A sound-dampening foam lines the interior of the shell. A cavity is defined by the sound-dampening foam and shaped to conform to a mobile telecommunications device, and the cavity is accessible through the opening. A sound-dampening foam layer is carried by the lid. The sound-dampening foam layer covers the cavity.

According to further aspects, a holder for a mobile telecommunications device includes a shell having an interior and an opening into the interior, a lid that removably covers the opening, the lid being attached to the shell by a hinge, a sound-dampening foam lining the interior of the shell, and a cavity defined by the sound-dampening foam and shaped to conform to a mobile telecommunications device. The cavity is accessible through the opening, and a sound-dampening foam layer carried by the lid covers the cavity. The holder also includes a fastener for attaching the holder to an interior surface of a vehicle passenger compartment.

Other aspects and advantages of the present invention will become apparent upon consideration of the following detailed description.

### BRIEF DESCRIPTION OF THE DRAWINGS

FIG. 1 is an isometric view of a holder according to one aspect of the present invention in use in the passenger compartment of an automobile;

FIG. 2 is an isometric view of the holder shown in FIG. 1 with portions cut away to show interior aspects thereof and a mobile telecommunications device carried therein;

FIG. 3 is a cross-sectional view along the line 3-3 in FIG. 2 with the mobile telecommunications device removed for clarity;

FIG. 4 is an isometric view of the invention according to another aspect with portions cut away to show the interior thereof;

FIG. 5 is a top isometric view of the holder shown in FIG. 4; and

FIG. 6 is a bottom isometric view of the holder shown in FIG. 4.

### DETAILED DESCRIPTION

Turning now to the drawings, FIGS. 1-3 show a holder 10 for a mobile telecommunications device 12 according to one aspect in the invention. The mobile telecommunications device may be any device that receives and/or transmits wireless communications signals, either currently known or developed in the future, such as by way of non-limiting examples, a cellular telephone, satellite telephone, wireless telephone, pager, wireless email device, wireless text messaging device, and the like.

The holder 10 generally is in the shape of a cup designed to fit in a standard cup holder that is frequently found in a passenger compartment 14 of an automobile. It should be noted that the invention is not limited in its use to any particular automobile, however, and may be used with any vehicle, such as a car, truck, motorcycle, boat, airplane, train, and the like. An exemplary standard cup holder is a blind bore 16 having a generally cylindrical shape, as shown in FIG. 1, for holding a cup that has a generally cylindrical shape. Other exemplary standard cup holders may simply include a circular ring that can hold a cup with a generally cylindrical shape. It should be noted that the term “generally cylindrical” as used herein is meant to include cups that are not exactly cylindrical, such as cups with a slightly conical exterior form factor that is narrow at a bottom of the cup and larger at the top of the cup, or other exterior form factors that have a generally smooth outer side wall, with or without a handle, that is substantially vertical and substantially straight in the vertical direction within reasonable limits of variation.

The holder 10 has an exterior form factor in the shape of a cup that is generally cylindrical. The holder 10 includes a container 18 having an outer shell 20 that is preferably made of a hard thermoplastic, but other suitable materials are equally applicable and also may be used. The outer shell 20 has a generally cylindrical side wall 22 extending upwardly from a bottom wall 24 and defining an opening 26 at a top 27 of the side wall 22. The bottom wall 24 is a flat disc shape, and the side wall 22 has a radially inward step near the bottom that defines a small shoulder 28, wherein a radius of the outer shell 20 is smaller immediately below the shoulder 28 than the radius immediately above the shoulder 28. The radially inward step can allow the container 18 to fit into different sized cup holders in a manner that would be known to one of skill in the art. Other variations to the outer form factor of the shell 20 may also be used that would cause the holder 10 to be able to be adapted to the shape of other various shapes and/or sizes of standard cup holders. The outer shell 20 is preferably rigid but in some cases may be formed of a soft material, such as cloth or flexible plastic. Additionally, the outer shell 20 is preferably opaque so that an interior 29 of the container is not visible from the outside, thereby preventing the driver from seeing lights or other visual cues from the mobile telecommunications device 12.

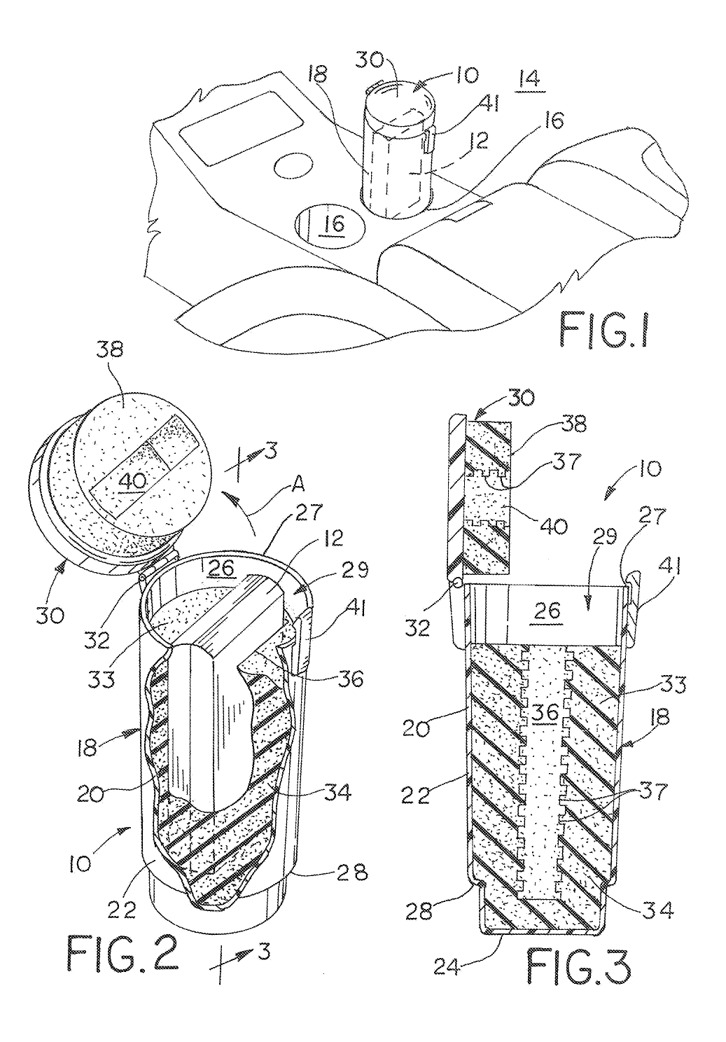

A lid 30 covers the opening 26 of the container 18. Preferably, the lid 30 is permanently attached to the side wall 20, such as with a hinge 32. The lid 30 may be moved from a closed position that covers the opening 26, as shown in FIG. 1, to an open position that exposes the opening 26 by pivoting the lid 30 about the hinge 32, as shown by arrow A in FIG. 2. In some embodiments, the lid 30 need not be attached to the container 18 by the hinge. For example, the lid 30 may simply have a friction fit with the outer shell 20 or in the opening 26 or the lid 30 may have a threaded connection to the shell 20, a snap fit connection or other suitable ways of releasably attaching the lid 30 to the container 18 to cover the opening 26. However, it is preferred that the lid 30 be permanently attached to the container 18 by some mechanism, such as the hinge 32, a chain, or plastic tether, for example, in order to prevent the lid 30 from being separated from the container and/or lost.

A dampening material 33 is disposed in the interior 29 of the container 18 for enveloping the mobile telecommunications device 12. The dampening material muffles sounds and dampens vibrations emitted by the mobile telecommunications device 12, and dampens shocks that may be imparted to the mobile telecommunications device 12, such as from dropping the holder or from a vehicle crash. The dampening material 33 is preferably in the form of a liner, such as a foam insert 34 that substantially conforms to the interior shape of the outer shell 20 and completely or substantially fills the interior 29 of the container 18. It is understood that the foam insert 34 is not limited to be formed by inserting a completed form into the container 18, but may be manufactured therein in any convenient or desirable method. The dampening material 33 preferably is sufficient to prevent or substantially reduce sounds or vibrations emitted by the mobile telecommunications device 12 disposed inside the container 18 from being heard or felt by a driver of the vehicle. The dampening material 33 is preferably a material that is lightweight and substantially muffles sounds and vibrations typically emitted by the mobile telecommunications device 12. The dampening material 33 is preferably also shock absorbent so that the mobile telecommunications device 12 is protected from impacts such as those caused when the vehicle hits a pothole or is in a crash. Additionally, the dampening material 33 and other materials of the container 18 are preferably materials that would not prevent the mobile telecommunications device 12 from receiving incoming wirelessly transmitted telecommunication signals, such as calls and text messages, when the mobile telecommunications device 12 is disposed within the container 18. Some dampening materials that are contemplated as being sufficient include common open cell foams and closed cell foams, including, for example, polyurethane or latex foam rubbers, extruded polystyrene foams, and/or other known acoustical dampening materials. Other dampening materials may include cloth, insulation, rubber, plastic, or other materials that would meet the sound, vibration, and shock dampening objectives of the invention. The dampening material is preferably formed of flexible closed cell foam.

A cavity 36 that is shaped to receive the mobile telecommunications device 12 therein through the opening 26 is formed in the foam insert 34. The cavity 36 preferably has the shape of a slot that has a form factor shaped and sized to conform closely to the shape of the mobile telecommunications device 12. Thus, for example, because many so-called smart phones today are in the shape of a thin rectangular plate, one preferred shape of the cavity 36 is a generally rectangular slot with an opening at the top of the foam insert 34 that is accessible through the opening 26. Preferably, the slot is slightly larger than the size of the mobile telecommunications device 12 such that the mobile telecommunications device has a slip fit in the slot.

A layer of the dampening material 33, such as a foam strip 38, is also disposed on an interior side of the lid 30 such that the layer of the dampening material 33 will cover the opening into the cavity 36 of the foam insert 34 when the lid is closed. Thus, when the lid 30 is closed, the cavity 36 and the mobile telecommunications device 12 therein are substantially surrounded and enveloped by the dampening material 33 so that noises and vibrations from the mobile telecommunications device 12 inside the cavity are reduced and/or completely silenced to a person in the passenger compartment of the vehicle. The foam strip 38 may also include another slot 40 therein located in such manner that an upper portion of the mobile telecommunications device 12 disposed in the cavity 36 is accepted within the slot 40, whereby the mobile telecommunications device 12 is completely enveloped and surrounded by the dampening material 33.

As best seen in FIG. 3, the interior side surfaces of the cavity 36 and the slot 40 preferably are lined with projections 37 to allow the cavity 36 and slot 40 to snuggly receive different shapes and sizes of mobile telecommunications devices. The projections 37 are preferably flexible. The projections 37 may be formed by, for example, molding or cutting of the foam insert 34. The projections 37 may take on many different shapes. One exemplary shape is egg-carton undulations, such as a series of dome-shaped projections or dome-shaped recesses. Another exemplary shape is an array of rectangular or circular projections, or fingers. The projections 37 are preferably spaced apart in either a regular or a random array and are sized to accommodate mobile telecommunications devices of different widths, for example from about 5 mm thick to about 30 mm thick. The interior side surface of the cavity 36 may, alternatively, be smooth, i.e., without the projections 37. In such case, the cavity 36 may be shaped to receive a particular style or size of mobile telecommunications device, and different foam inserts 34 may be made available to accommodate different mobile telecommunications devices.

A latch mechanism 41 is carried by the shell 20 for releasably latching the lid 30 in the closed position covering the opening 26. The latch 41 may comprise a mechanical latch, such as a resilient member carried by the shell that snap fits to a complimentary portion of the lid 30, as shown in FIGS. 1-3. Other suitable mechanisms for latching the lid 30 in a closed position that covers the opening 26 may also or alternatively be used as would be clear to a person of ordinary skill in the art.

Although the holder 10 in FIGS. 1-3 is shown in the shape and form factor of a generally cylindrical cup, the exterior form factor of the holder can take many different forms and shapes. For example, the holder could be in the shape of a cube or a rectangle or an octagonal cup or really any other shape capable of holding and completely enveloping the mobile telecommunications device therein. For example, in FIGS. 4-6, another embodiment of a holder 10a for the mobile telecommunications device 12 is shown, wherein the container 18 has a generally rectangular exterior form factor. Other than the exterior form factor, the holder 10a is substantially functionally identical to the holder 10 of FIGS. 1-3 except as discussed herein below. Therefore, similar or identical features are identified with the same reference numbers where appropriate.

As shown in FIGS. 4-6, the holder 10a has a container 18 with an outer shell 20 as previously described, but having a front wall 22a, back wall 22b, bottom wall (not visible), and opposite side walls 22c and 22d, and a lid 30 that is attached to the back wall 22b by a hinge 32. A foam insert 34 of dampening material 33 lines the interior 29 of the container 18 and has a cavity 36 centrally located therein that conforms to the shape of a mobile telecommunications device 12 as previously described. The lid 30 covers an opening 26 into the container 18 and may be opened to expose the opening 26 through which the cavity 36 is accessible. Dampening material, such as foam strip 38, is disposed on an interior side of the lid 30 such that the mobile telecommunications device 12 carried within the cavity 36 is substantially or completely surrounded and enveloped by the dampening material when the lid is closed as previously described. The holder 10a preferably also includes a latch 41 to releasably latch the lid 30 into the closed position as previously described.

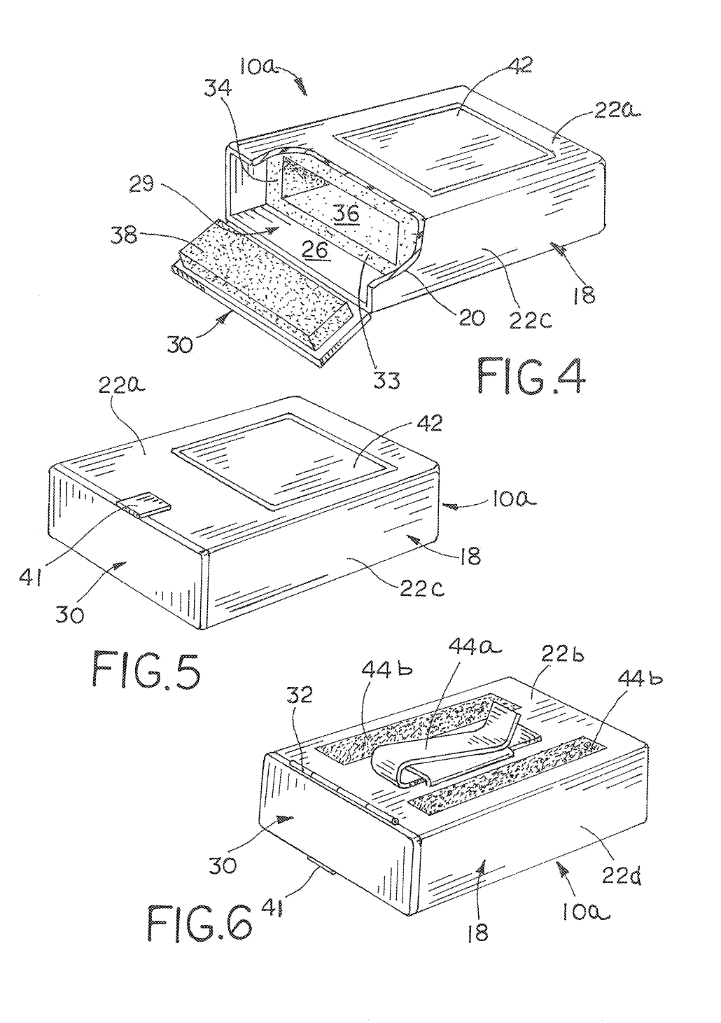

As shown in FIGS. 4 and 5, the holders 10, 10a may include a picture holder 42 on an exterior thereof, such as on the front wall 22a. Having a picture of loved ones, such as parents or children or spouse, visible in the picture holder may serve as a reminder to the driver of the importance of proper usage of the telecommunications device while operating a vehicle. Thus, the picture holder 42 preferably has a form wherein a picture is carried within a cavity and the picture is visible to a viewer outside of the cavity in any manner readily apparent to one of ordinary skill in the art. It is also contemplated that the holders 10, 10a may include other reminders, such as a written reminder in addition to or in place of the picture holder 42, to remind the driver of the dangers using the mobile phone while driving.

As shown in FIG. 6, the holders 10, 10a may also include a fastener 44 on an exterior of the container 18. Thus, for example, in FIG. 6, one exemplary fastener 44 is a resilient clip that would be adapted to removably attach the holder to a sun visor in the vehicle. Another exemplary fastener 44 is one or more hook-and-loop fasteners that can be attached to complimentary hook or loop fasteners disposed on some interior portion of the vehicle. In FIG. 6, the fasteners 44 are shown on the back wall 22b of the outer shell 20. Either or both of the resilient clip and the hook-and-loop fasteners may be disposed on the outer shell. Further, the fasteners 44 may be disposed at other locations on the outer shell that would be sufficient or more preferred for containers with different exterior form factors and/or different attachment surfaces within the passenger compartment 14 of the vehicle, as would be apparent to a person of skill in the art. The fastener 44 can be helpful for maintaining the holder 10, 10a, and thus the mobile telecommunications device 12, in a known and readily accessible location in case of, for example, the occurrence of a crash. This may be particularly helpful in the instance of the holder 10a that is not necessarily specially adapted for placement within the cup holder and therefore would benefit from having a fastener 44 for attaching the holder in a pre-selected location in the vehicle.

### INDUSTRIAL APPLICABILITY

The holder for a mobile telecommunications device described herein advantageously can be used to remove the temptation to use the mobile telecommunications device while in a vehicle by preventing the driver from observing any indication, such as sounds, vibrations, or lights, that the mobile telecommunications device received an incoming wireless transmission. The holder also allows for the convenient and accessible placement of the mobile telecommunications device within the vehicle.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved. All patents, patent applications, and other printed publications identified in this foregoing are incorporated by reference in their entireties herein.

I claim:

1. A holder for a mobile telecommunications device comprising:
a container having an interior and an opening into the interior;
a lid permanently attached to the container, wherein the lid shifts between a closed position that covers the opening and an open position that exposes the opening;
a dampening material lining the interior, wherein the dampening material dampens sounds, vibrations, and shocks; and
a cavity in the dampening material shaped to receive the mobile telecommunications device;
wherein the mobile telecommunications device can be inserted into the cavity through the opening when the lid is in the open position and the cavity is encapsulated by the dampening material when the lid is in the closed position, whereby any indications that the mobile telecommunications device in the cavity has received an incoming wireless transmission are not observable outside of the holder.

2. The holder of claim 1, wherein the lid is attached to the container by a hinge and the container includes a latch that releasably secures the lid in a closed position.

3. The holder of claim 2, wherein an interior side surface of the cavity includes a plurality of spaced apart flexible projections.

4. The holder of claim 1, wherein the dampening material comprises a foam insert that substantially fills the interior of the container and a foam lining an interior of the lid that covers the cavity when the lid is closed.

5. The holder of claim 4, wherein the dampening material prevents any sound and/or vibration from a mobile telecommunications device in the cavity from being observed outside of the holder when the lid is closed.

6. The holder of claim 1, wherein the holder has the shape of a cup.

7. The holder of claim 6, wherein the holder is adapted to fit into a cup holder in a vehicle.

8. The holder of claim 1, wherein the container includes a fastener on an external wall thereof adapted to attach the container to an interior surface of a vehicle.

9. The holder of claim 8, wherein the fastener comprises a clip adapted to clip the holder to a sun visor in the vehicle.

10. The holder of claim 8, wherein the fastener comprises a hook and loop fastener mechanism.

11. The holder of claim 1, wherein the container is opaque, whereby visual signals from a mobile telecommunications device in the cavity cannot be seen outside of the holder.

12. The holder of claim 1, wherein the dampening material comprises flexible foam.

13. The holder of claim 1, wherein the container does not prevent a mobile telecommunications device carried in the cavity from receiving incoming wirelessly transmitted telecommunications signals.

14. The holder of claim 13, wherein the telecommunications device comprises a cellular telephone, the container comprises a rigid outer shell, and the lid comprises a rigid body.

15. The holder of claim 14, further comprising a picture holder pocket on an exterior of the outer shell or lid.

16. A holder for a mobile telecommunications device, the holder comprising:
a cup-shaped shell having a bottom, a generally cylindrical sidewall, and an opening into an interior at a top of the sidewall;
a lid permanently attached to the shell, wherein the lid is movable from a closed position that covers the opening to an open position that exposes the opening;
a sound-dampening foam completely lining the interior of the shell;
a cavity defined by the sound-dampening foam and shaped to conform to a mobile telecommunications device, the cavity being accessible through the opening; and
a sound-dampening foam layer carried by the lid, the sound-dampening foam layer covering the cavity.

17. The holder of claim 16, further comprising a hinge pivotably attaching the lid to the cup-shaped shell, and a latch for releasably latching the lid in a closed position covering the opening.

18. A holder for a mobile telecommunications device, the holder comprising:
a shell having an interior and an opening into the interior;
a lid that removably covers the opening, the lid being attached to the shell by a hinge;
a sound-dampening foam completely lining the interior of the shell;
a cavity defined by the sound-dampening foam and shaped to conform to a mobile telecommunications device, the cavity being accessible through the opening;
a sound-dampening foam layer carried by the lid, the sound-dampening foam layer covering the cavity; and
a fastener for attaching the holder to an interior surface of a vehicle passenger compartment.

19. The holder of claim 18, wherein the fastener comprises a resilient clip.

20. The holder of claim 19, wherein the fastener comprises a hook and loop fastener.
